(19) United States
(12) Patent Application Publication
(10) Pub. No.: US 2006/0064378 A1
(43) Pub. Date: Mar. 23, 2006

(54) METHOD AND APPARATUS FOR MAINTAINING LINKED ACCOUNTS

(76) Inventors: Jeff Clementz, Campbell, CA (US); Franck Chastagnol, Redwood City, CA (US); Hugo Olliphant, San Francisco, CA (US)

Correspondence Address: SCHWEGMAN, LUNDBERG, WOESSNER & KLUTH, 1600 TCF TOWER, 121 SOUTH EIGHT STREET, MINNEAPOLIS, MN, 55402, US

(21) Appl. No.: 10/946,710

(22) Filed: Sep. 21, 2004

(51) Int. Cl. G06Q 40/00

(52) U.S. Cl. 705/40

(57) ABSTRACT

A method and apparatus for maintaining liked accounts for participants of network-based marketplaces are described. In one embodiment, a master account is maintained for a master account holder, and one or more sub-accounts linked to the master account are maintained for one or more sub-account holders. The sub-accounts are funded using at least one funding source of the master account.

### FIELD OF THE INVENTION

Embodiments of the present invention relate generally to the field of e-commerce and, more specifically, to managing online user accounts.

### BACKGROUND OF THE INVENTION

An electronic payment system allows participants of network-based marketplaces to make and collect payments online. For example, the payer may send money to the electronic payment system using a credit card or check, or funds in a payer account maintained by the electronic payment system. Recipients can store money in their accounts maintained by the electronic payment system, transfer the money to a separate bank account or have the electronic payment system cut them a check.

A typical electronic payment system allows a user to create an account if the user is at least 18 years old and can provide a unique financial instrument (e.g., a unique bank account or a credit card) to fund the account. Usually, the user can create an account by accessing the web site of the electronic payment system, entering required personal information and specifying the user's financial instrument(s) for funding the account.

### SUMMARY OF THE INVENTION

A method and apparatus for maintaining linked accounts for participants of network-based marketplaces are described. In one embodiment, a master account is maintained for a master account holder, and one or more sub-accounts linked to the master account are maintained for one or more sub-account holders. The sub-accounts are funded using at least one funding source of the master account.

### BRIEF DESCRIPTION OF THE DRAWINGS

Embodiments of the present invention are illustrated by way of example and not limitation in the figures of the accompanying drawings, in which like references indicate similar elements and in which:

FIG. 1 is a network diagram depicting a commerce system, according to one exemplary embodiment of the present invention;

FIG. 2 is a block diagram of one embodiment of a linked accounts module;

FIG. 3 is a flow diagram of one embodiment of a method for maintaining linked accounts for participants of network-based marketplaces;

FIG. 4 is a flow diagram of one embodiment of a method for creating linked accounts for participants of network-based marketplaces;

FIG. 5 is a block diagram of one embodiment of a system for managing online accounts of participants in network-based marketplaces;

FIG. 6A is a block diagram of one embodiment of an NSP account manager;

FIG. 6B is a block diagram of one embodiment of a payment account manager;

FIG. 7 is a flow diagram of one embodiment of a method for maintaining NSP wallets;

FIG. 8 is a flow diagram of one embodiment of a method for adding funds to a wallet of an NSP user;

FIG. 9 is a flow diagram of one embodiment of a method for maintaining online payment accounts of NSP users;

FIG. 10 is an exemplary representation of an ISP page user interface; and

FIG. 11 is a block diagram of one embodiment of a computer system.

### DETAILED DESCRIPTION

A method and system to manage online accounts of participants of network-based marketplaces are described. In the following description, for purposes of explanation, numerous specific details are set forth in order to provide a thorough understanding of the present invention. It will be evident, however, to one skilled in the art that the present invention may be practiced without these specific details.

### Platform Architecture

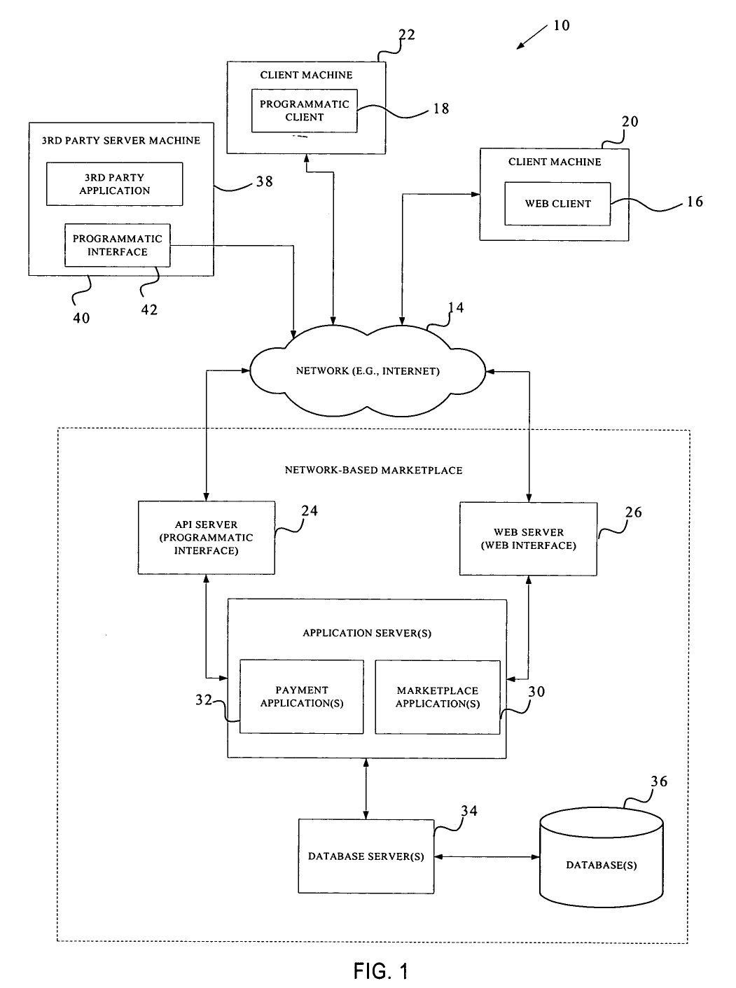

FIG. 1 is a network diagram depicting a commerce system 10, according to one exemplary embodiment of the present invention, having a client-server architecture. Specifically, a trading platform, in the exemplary form of a network-based marketplace 12, provides server-side functionality, via a network 14 (e.g., the Internet) to one or more clients. FIG. 1 illustrates, for example, a web client 16 (e.g., a browser, such as the INTERNET EXPLORER browser developed by Microsoft Corporation of Redmond, Wash. State), and a programmatic client 18 executing on respective client machines 20 and 22.

Turning specifically to the network-based marketplace 12, an Application Program Interface (API) server 24 and a web server 26 are coupled to, and provide programmatic and web interfaces respectively to, one or more application servers 28. The application servers 28 host one or more marketplace applications 30 and payment applications 32. In one embodiment, the application servers 28 include a marketplace server hosting one or more marketplace applications 30 and a payment server hosting one or more payment applications 32. The application servers 28 are coupled to one or more databases servers 34 that facilitate access to one or more databases 36.

The marketplace applications 30 provide a number of marketplace functions and services to clients that access the marketplace 12. The payment applications 32 likewise provide a number of payment services and functions to clients that access marketplace 12. While the marketplace and payment applications 30 and 32 are shown in FIG. 1 to both form part of the network-based marketplace 12, it will be appreciated that in alternative embodiments of the present invention, the payment applications 32 may form part of an online payment system that is separate and distinct from the marketplace 12. The online payment system may provide payment services and functions to clients that access various marketplaces.

Further, while the commerce system 10 shown in FIG. 1 employs a client-server architecture, the present invention is of course not limited to such an architecture, and could equally well find application in a distributed, or peer-to-peer, architecture system. The various marketplace and payment applications 30 and 32 could also be implemented as standalone software programs, which do not necessarily have networking capabilities.

The web client 16, it will be appreciated, accesses the various marketplace and payment applications 30 and 32 via the web interface supported by the web server 26. Similarly, the programmatic client 18 accesses the various services and functions provided by the marketplace and payment applications 30 and 32 via the programmatic interface provided by the API server 24. The programmatic client 18 may, for example, be a seller application (e.g., the TURBOLISTER application developed by eBay Inc., of San Jose, Calif.) to enable sellers to author and manage listings on the marketplace 12 in an off-line manner, and to perform batch-mode communications between the programmatic client 18 and the network-based marketplace 12.

FIG. 1 also illustrates a third party application 38, executing on a third party server machine 40, as having programmatic access to the network-based marketplace 12 via a programmatic interface 40 and the programmatic interface provided by the API server 24. For example, the third party application 38 may, utilizing information retrieved from the network-based marketplace 12, support one or more features or functions on a website hosted by the third party. The third party website may, for example, provide one or more marketplace or payment functions that are supported by the relevant applications of the network-based marketplace 12. An exemplary third party server machine 40 may be a server machine of a network service provider (e.g., a wireless service provider or Internet service provider), as will be discussed in more detail below.

### Linked Accounts

As discussed above, an online payment system may provide payment services and functions to clients that access one or more marketplaces. In one embodiment, the online payment system is coupled to the marketplace(s) via a communications network (e.g., an internal network, the wide area network, a wireless network, or the Plain Old Telephone Service (POTS) network). Alternatively, the online payment system is integrated with the marketplace and it is a part of the marketplace. The online payment system is also coupled to the clients via any of the described above communications networks.

In one embodiment, the online payment system includes a linked accounts module that enables shared funding sources between several users of the online payment system. The users sharing the funding sources may be, for example, family members, business partners, multi-businesses, etc.

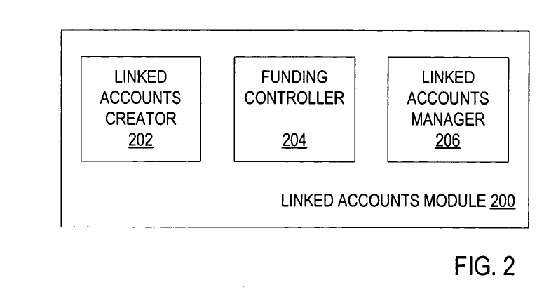

FIG. 2 is a block diagram of one embodiment of a linked accounts module 200. The linked accounts module 200 includes a linked accounts creator 202, a funding controller 204, and a linked accounts manager 206.

The linked accounts creator 202 is responsible for creating linked accounts. Linked accounts may be, for example, sub-accounts supported by a master account. A master account is associated with one or more financial instruments (e.g., a credit card, a bank account, etc.) that provide funding of the master account and its sub-accounts. The linked accounts creator 202 creates a sub-account in response to a request of a master account holder. A sub-account may be a new account. Alternatively, a sub-account may be an existing account that was previously independent or linked to a different master account.

In one embodiment, the linked accounts creator 202 presents a user interface that facilitates input of sub-account data by a master account holder. In one embodiment, the master account holder is required to specify a funding option for the sub-account being created. A funding option may, for example, specify the funding amount to be provided by the master account for the sub-account (e.g., if the sub-account holder is a child of the master account holder), a permission to share the funds of the master account (e.g., if the sub-account holder is a spouse of the master account holder), or a spending limit (e.g., a percentage of the total funds of the master account, the number of purchases, the type of purchases, etc.) allowed by the master account for the sub-account (e.g., if the sub-account holder is a business partner or an employee of the master account holder).

In one embodiment, a sub-account can be detached from a master account in response to a request from a sub-account holder. The linked accounts creator 202 detaches a sub-account by removing funding sources of the master account from the sub-account and attaching to the sub-account a new funding source specified by the sub-account holder.

The funding controller 204 is responsible for controlling funding of sub-accounts in accordance with relevant funding options. For example, if the funding option specifies a certain amount for funding the sub-account, the funding controller 204 debits the financial instrument of the master account with the specified amount and transfers this amount to the sub-account. In one embodiment, when the sub-account spends the assigned funds, the funding controller 204 notifies the sub-account holder and the master account holder (e.g., via email). The funding accounts 204 may also ask the master account holder whether he or she wants to provide more funds for the sub-account. In another example, if the chosen funding option specifies the spending limit for the sub-account, the funding controller 204 monitors expenses of the sub-account, checks whether a current purchase satisfies the spending limit, and if it does, debits the financial instrument of the master account with the amount of the current purchase, and makes this amount available for payment. If the current purchase exceeds the spending limit, the funding controller 204 does not allow the payment and notifies the sub-account holder and the master account holder. In one embodiment, the funding controller 204 locks the sub-account when the current purchase exceeds the spending limit.

The linked accounts manager 206 is responsible for maintaining the master account and linked sub-accounts, and providing separate financial tracking for each account. In one embodiment, the linked accounts manager 206 allows the master account holder to access all sub-accounts of the master account. For example, the linked accounts manager 206 may allow the master account holder to view a summary of all sub-accounts and activities of individual sub-accounts. The linked accounts manager 206 may also notify the master account holder each time the sub-account holder sends a payment for purchased goods or services.

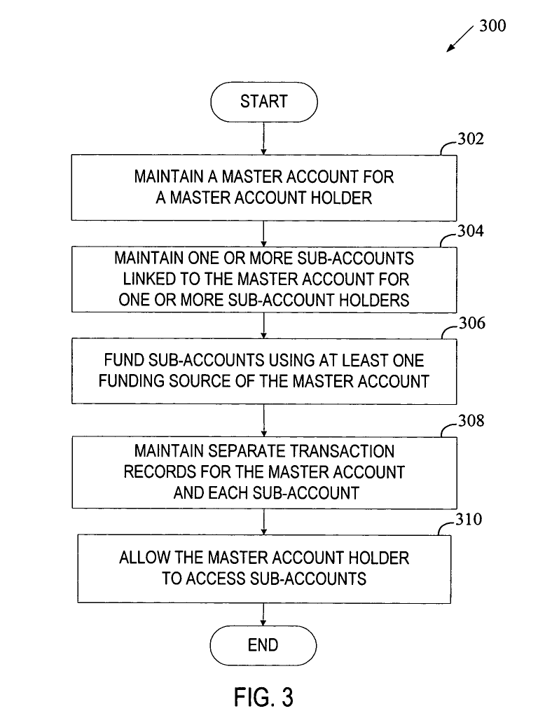

FIG. 3 is a flow diagram of one embodiment of a method 300 for maintaining linked accounts for participants of network-based marketplaces. Method 300 may be performed by processing logic, which may comprise hardware, software, or a combination of both. Processing logic may reside either in the online payment system, or partially or entirely in a separate device and/or system(s).

Method 300 begins with the linked accounts manager 206 maintaining a master account for a master account holder (processing block 302) and one or more sub-accounts linked to the master account for sub-account holders (processing block 304). A sub-account holder may be, for example, a spouse of a master account holder, a child of a master account holder, a business partner of a master account holder, an employee of a master account holder, etc.

At processing block 306, the funding controller 204 funds the sub-accounts using one or more financial instruments of the master account. The financial instruments may include a bank account, a credit card, a debit card, or any other funding source associated with the master account. In one embodiment, the funding controller 204 provides funds to the sub-accounts according to funding information specified by the master account holder. The funding information may indicate a spending limit with respect to the funds of the master account for the sub-account (e.g., a percentage of the total funds of the master account, a maximum number of purchases, etc.) or the funding amount to be provided for the sub-account. Alternatively, the funding information may indicate that the sub-account is permitted to share one or more funding sources of the master account with no limit.

At processing block 308, the linked accounts manager 206 maintains separate transaction records for the master account and each linked sub-account. Upon receiving a request of the master account holder, the linked accounts manager 206 allows the master account holder to access sub-account information (processing block 310). The sub-account information may include, for example, a summary view of sub-accounts, activities of individual sub-accounts, personal information of sub-account holders, finding options associated with sub-accounts, etc.

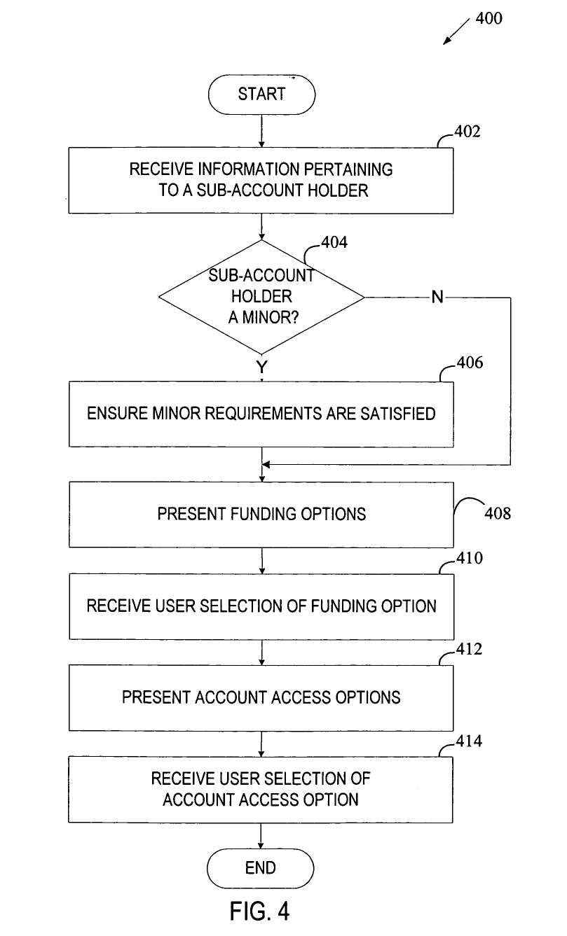

FIG. 4 is a flow diagram of one embodiment of a method 400 for creating linked accounts for participants of network-based marketplaces. Method 400 may be performed by processing logic, which may comprise hardware, software, or a combination of both. Processing logic may reside either in the online payment system, or partially or entirely in a separate device and/or system(s).

Method 400 begins with the linked accounts creator 202 presenting to a user a linked account page, receiving the user's request to initiate creation of a sub-account for the present account of the user, and presenting an account naming page to the user. A sub-account being created may be a new account or an existing account that was previously independent or linked to a different master account.

Next, the linked account creator 202 receives information pertaining to a sub-account holder (e.g., name, email address, password, account number if an existing account, whether the sub-account holder is a minor, etc.) provided by the user on the account naming page (processing block 402) and stores this information in a database with the information identifying the master account to which the sub-account should be linked.

At processing box 404, the linked accounts creator 202 determines whether the sub-account holder is a minor. If so, the linked accounts creator 202 asks the user to provide the age of the child and to sign a minor-related agreement (e.g., Minor Terms and Conditions, Children's Online Parental Act, etc.). Depending on the predetermined minor requirements, only children older than a certain age (e.g., 13 years) may be allowed to be a sub-account holder.

Upon ensuring that the minor's requirements are satisfied (processing block 406) or upon determining that the sub-account holder is not a minor, the linked accounts creator 202 presents funding options to the user (processing block 408). The funding options may be displayed as, for example, radio buttons or check boxes. The funding options may include an option to provide an exact amount to find the sub-account, an option to provide a limit on the percentage of the total funds that the sub-account can spend, an option to allow the sub-account to share one or more financial instruments of the master account without limit, etc.

At processing block 410, the linked accounts creator 202 receives the user's selection of a desired funding option and stores the selected finding option in the database with the other information pertaining to the sub-account.

Further, the linked accounts creator 202 presents account access options (e.g., options to view certain information about the master and sub accounts, to receive notifications on certain events, etc.) to the user (processing block 412), receives the user's selection of a desired account access option (processing block 412), and saves the selected account access option in the database.

Once the sub-account is created, it can function as any other account. For example, the sub-account holder can login into the sub-account using his or her login ID and password, access the account's overview and history, send money to various recipients (if the payment satisfies the relevant funding option) or receive money from various senders, etc. In one embodiment, when the sub-account holder uses his or her sub-account to make payments or make bids requiring an immediate payment, the online payment system 250 locks the sub-account if the total amount of payments or bids reaches the sub-account balance or spending limit, as defined by the corresponding funding option.

The master account may support numerous sub-accounts, each with its own funding option. The master account holder is allowed to access sub-account information and to change funding options and other sub-account options.

A sub-account holder may provide a new funding source and request to detach the sub-account from the master account. In response, the linked accounts creator 202 may remove the link between the master account and the sub-account and associate the sub-account with the new funding source, thus converting the sub-account into an independent account.

Network Service Provider Wallet

In one embodiment, an online payment system may be coupled with a network service provider (NSP) (e.g., an Internet Service Provider (ISP) or a wireless service provider) to provide NSP subscribers with online payment accounts maintained by the online payment system and accessible to the NSP subscribers via the NSP system.

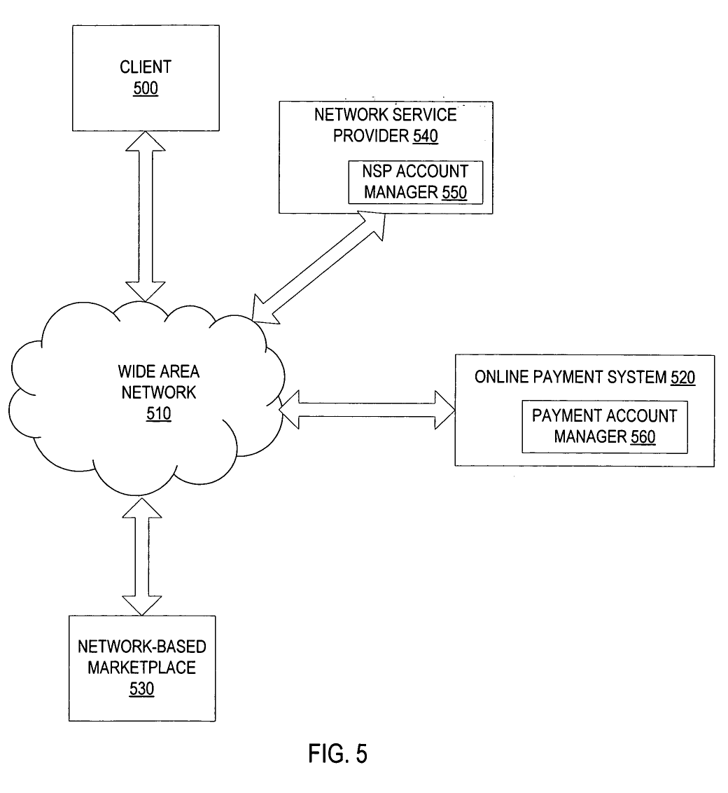

FIG. 5 is a block diagram of one embodiment of a system for managing online accounts of participants in network-based marketplaces. In this embodiment, a client 500 is coupled to a network-based marketplace 530 via a communications network, including a wide area network 510 such as the Internet. Other examples of networks that the client may utilize to access the marketplace 530 include a local area network (LAN), a wireless network (e.g., a cellular network), or the Plain Old Telephone Service (POTS) network.

The marketplace 530 is coupled to an online payment system 520. In one embodiment, the marketplace 530 is coupled to the online payment system 520 via a communications network such as an internal network, the wide area network 510, a wireless network (e.g., a cellular network), the Plain Old Telephone Service (POTS) network, etc. Alternatively, the online payment system 520 may be integrated with the marketplace 530 and it is a part of the marketplace 530. The online payment system 520 is also coupled to the client 500 via any of the described above communications networks. In one embodiment, the online payment system 520 includes a payment account manager 560 that is responsible for maintaining online payment accounts for participants of the marketplace 530 and various other marketplaces.

The marketplace 530 is coupled to a network service provider (NSP) system 540, such as an ISP or a wireless service provider system. The NSP 540 provides network access for its subscribers including the user of the client 500. In one embodiment, the NSP 540 includes an NSP account manager 550 that is responsible for maintaining NSP accounts for its subscribers and generating bills for services provided by the NSP 540. In one embodiment, the NSP account manager 550 cooperates with the payment account manager 560 to provide the NSP subscribers with online payment accounts created via the NSP 540 (e.g., using a website hosted by the NSP 540), maintained by the online payment system 520 and accessible to the NSP subscribers via the NSP 540 (e.g., the NSP website). These accounts allow the NSP subscribers to make payments at various marketplaces and are referred to herein as NSP wallets.

In an alternative embodiment, the online payment system 520 is integrated with the NSP system 540 and is a part of the NSP system 540.

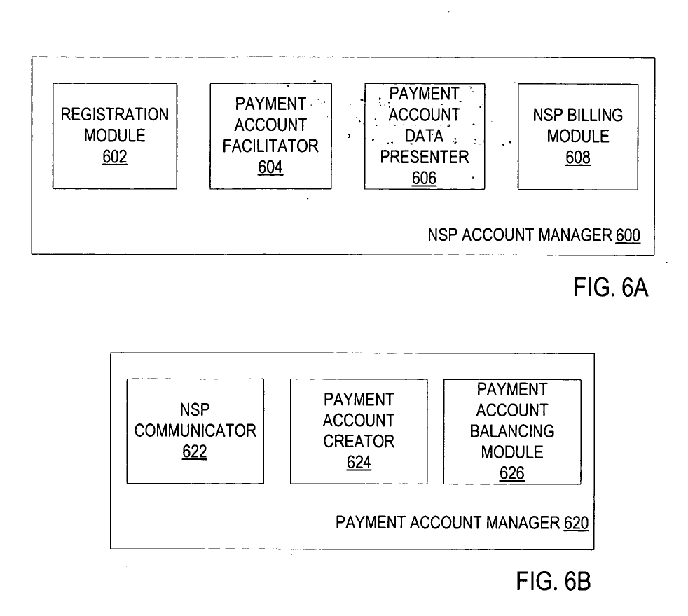

FIG. 6A is a block diagram of one embodiment of an NSP account manager 600. The NSP account manager 600 includes a registration module 602, a payment account facilitator 604, a payment account data presenter 606, and an NSP billing module 608.

The registration module 602 is responsible for registering new users with the NSP for services offered by the NSP. Prior to registering a new user or during the registration, the registration module 602 offers the new user the option to create an online payment account for this user. In one embodiment, the user is not required to provide a financial instrument to fund this account. Rather, the funding of the account is done by the NSP as will be discussed in more detail below. As part of registration, the registration module 602 receives registration information (e.g., name, address, etc.) from the user subscribing for services offered by the NSP and stores this information in a database. In one embodiment, the registration module 602 assigns an email address to each new NSP user.

The payment account facilitator 604 is responsible for requesting the online payment system 520 to open an online payment account for an NSP user. In one embodiment, the payment account facilitator 604 sends the request to create an online payment account for the NSP user with relevant registration information of the NSP user (e.g., the email address). In one embodiment, the payment account facilitator 604 issues the request to create an account during the registration of the new user. Alternatively, the payment account facilitator 604 issues this request subsequent to the registration process, upon receiving an explicit instruction from an existing user (e.g., when the existing user clicks a designated link on an NSP web page).

The payment account facilitator 604 may also be responsible for requesting the online payment system 520 to add money to the online payment account of the NSP user. The payment account facilitator 604 may issue such a request in response to a request from the NSP user (e.g., when the NSP user clicks a designated button on an NSP web page).

The payment account data presenter 606 is responsible for providing access to the online payment account for the NSP user. For example, a page hosted by the NSP may include a radio button “View Wallet Balance”. When the user activates this radio button, the payment account data presenter 606 requests wallet information from the online payment system 520 and makes the wallet information to be available to the NSP user.

The NSP billing module 608 is responsible for recording services received by the NSP user from the NSP, updating the balance of the user NSP account with fees charged for these services, and periodically generating a bill for the balance of the NSP account. The amount of the bill reflects requested transfers of funds to the online payment account of the NSP user.

FIG. 6B is a block diagram of one embodiment of a payment account manager 620. The payment account manager 620 includes an NSP communicator 622, a payment account creator 624, and a payment account balancing module 626.

The NSP communicator 622 is responsible for receiving information pertaining to NSP users from the NSP. This information may include requests to open new online payment accounts for NSP users with registration information of the NSP users, requests to add funds to online payment accounts of NSP users, requests to provide payment account data, etc. The NSP communicator 622 may also be responsible for transferring payment account data to the NSP.

The payment account creator 624 is responsible for creating online payment accounts for NSP users. In one embodiment, the payment account creator 624 attaches a new payment account to an email address assigned to a NSP user by the NSP.

The payment account balancing module 626 is responsible for adding funds to online payment accounts of NSP users in response to requests received from the NSP.

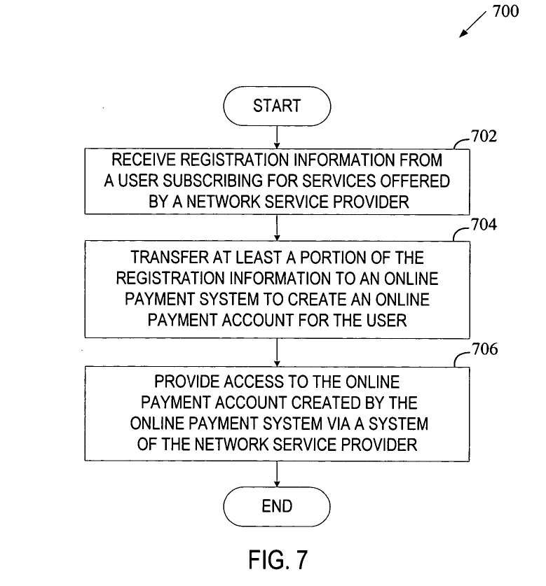

FIG. 7 is a flow diagram of one embodiment of a method 700 for maintaining NSP wallets. Method 700 may be performed by processing logic, which may comprise hardware, software, or a combination of both. Processing logic may reside either in the NSP system, or partially or entirely in a separate device and/or system(s).

Method 700 begins with the registration module 602 receiving registration information from a user subscribing for services offered by an NSP (processing block 702). An NSP may be an ISP, a wireless service provider, or any other provider of network access. Upon receiving the user registration information, the registration module 602 registers the user with the NSP and, in one embodiment, assigns an NSP account and an NSP emails address to the user. The NSP account records fees for services provided by the NSP for the NSP user.

At processing block 704, the payment account facilitator 604 transfers at least a portion of the registration information to an online payment system to create an online payment account (referred as an NSP wallet) for the user. In one embodiment, the payment account facilitator 604 transfers the user's registration information (including the user's email address assigned to the user by the registration module 602) to the online payment system when registering a new NSP user with the NSP. In another embodiment, the payment account facilitator 604 transfers the user's registration information to the online payment system when receiving a request to open an online payment account from an existing NSP user.

The NSP offers every new customer subscribing to the NSP service an option to automatically create a new online payment account and to credit this online payment account with a specific amount (e.g., $10) as an incentive. In this embodiment, the payment account facilitator 604 transfers the user's registration information to the online payment system with the request to credit the new online payment account with the relevant amount.

Upon receiving the registration information of the NSP user, the online payment system creates an online payment account for the NSP user. The NSP user may then use the online payment account to make online payments at various marketplaces.

At processing block 706, the payment account data presenter 606 provides access to the online payment account for the NSP user via the NSP system. For example, a page hosted by the NSP may include a link to the online payment account. When the user clicks the link, the payment account data presenter 606 requests online payment account information from the online payment system and presents the information returned by the online payment system to the user. Alternatively, when the user clicks the link, the payment account data presenter 606 redirects the NSP user to a page hosted by the online payment system that displays the payment account information. In one embodiment, pages presenting payment account information contain logos of both the NSP and the online payment system.

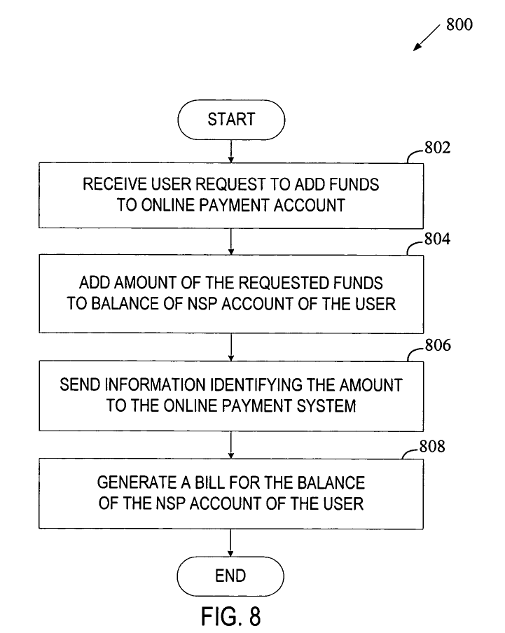

FIG. 8 is a flow diagram of one embodiment of a method 800 for adding funds to a wallet of an NSP user. Method 800 may be performed by processing logic, which may comprise hardware, software, or a combination of both. Processing logic may reside either in the NSP system, or partially or entirely in a separate device and/or system(s).

Method 800 begins with the payment account facilitator 604 receiving a user request to add funds to a wallet (an online payment account) of an NSP user (processing block 802). Such a request may be received when the NSP user clicks the “Add Funds” button on a page hosted by the NSP (e.g., “My ISP Page”). The NSP user may also need to specify the amount.

At processing block 804, the payment account facilitator 604 adds the amount of the requested funds to the balance of an NSP account of the NSP user.

At processing block 806, the payment account facilitator 604 sends information identifying the amount of the requested funds to the online payment system. The online payment system then credits the wallet with the requested amount.

At processing block 808, the NSP billing module 608 generates a bill for the balance of the NSP account of the NSP user.

In one embodiment, an NSP user (a master account holder) is allowed to share his or her wallet with others (e.g., his or her family members). In this embodiment, the payment account facilitator 604 receives user input specifying other users of the wallet (sub-account holders) and a spending limit for each sub-account holder. The spending limit may indicate, for example, a limit on a spending amount, a limit on the number of purchases, a limit on the type of purchases, etc. The payment account facilitator 604 transfers this information to the online payment system, which ensures that sub-accounts do not exceed their spending limits.

In one embodiment, the payment account data presenter 606 allows each sub-account holder to view his or her sub-account. The master account holder is allowed to view the entire wallet.

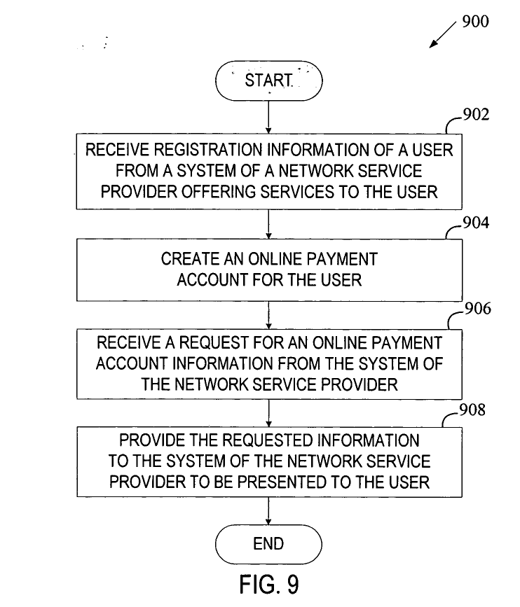

FIG. 9 is a flow diagram of one embodiment of a method 900 for maintaining online payment accounts of NSP users. Method 900 may be performed by processing logic, which may comprise hardware, software, or a combination of both. Processing logic may reside either in the online payment system, or partially or entirely in a separate device and/or system(s).

Method 900 begins with the NSP communicator 622 receiving registration information of an NSP user from an NSP (processing block 902). The registration information may include an email address assigned to the NSP user by the NSP.

At processing block 904, the payment account creator 624 creates an online payment account for the NSP user. In one embodiment, the online payment account is funded by the NSP, which then bills the NSP user for the resulting balance. In one embodiment, the payment account creator 624 associates the online payment account with the email address assigned to the NSP user by the NSP.

Once the online payment account is created, the NSP user may use it to make payments at various marketplaces. For example, the NSP user may use his or her online payment account to pay for a shopping cart on a merchant website. In particular, if the NSP user clicks a button associated with the online payment system on the merchant website, the NSP user may be presented with a page hosted by the online payment system that may ask the NSP user to login to the online payment system to confirm the payment.

At processing block 906, the NSP communicator 622 receives a request for payment account information from the NSP. The request identifies the NSP user who requested this information.

At processing block 908, the NSP communicator 622 provides the requested information to the NSP, which presents it to the NSP user. In an alternative embodiment, the NSP communicator 622 provides to the NSP an IP address of web pages containing the payment account information, and the NSP redirects the NSP user to these pages. In one embodiment, the pages with the payment account information include logos of both the NSP and the online payment system.

In one embodiment, the NSP communicator 622 receives a request to add funds to the online payment account of the NSP user and invokes the payment account balancing module 626 to add the requested amount to the balance of the online payment account.

In one embodiment, the NSP communicator 622 receives information identifying other users allowed to use funds of the online payment account and a spending limit associated with each of the other users. In response, the payment account creator 624 creates sub-accounts linked to the existing online payment account (master account) and associates each sub-account with the corresponding spending limit. The payment account balancing module 626 then monitors transactions performed by sub-account holders to ensure that the relevant spending limits are not exceeded.

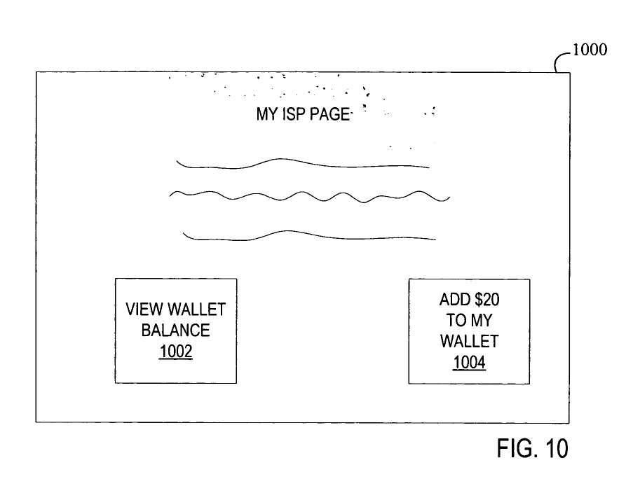

FIG. 10 illustrates an exemplary user interface 1000. The user interface 1000 presents My ISP page that includes buttons 1002 and 1004.

The button 1002 allows an ISP user to view the balance of his or her wallet. In one embodiment, the ISP user is a master account holder, the ISP user can view the entire wallet, including account information pertaining to sub-account holders. If the ISP user is a sub-account holder, this ISP user can only view information pertaining to his or her account.

The button 1004 allows the ISP user to add funds to the wallet. When the ISP user clicks the button 1004, the ISP makes an API call to the online payment system to credit the online payment account of the ISP user. Subsequently, the ISP user receives a bill from the ISP that reflects the amount added to the online payment account of the ISP user.

Exemplary Computer System

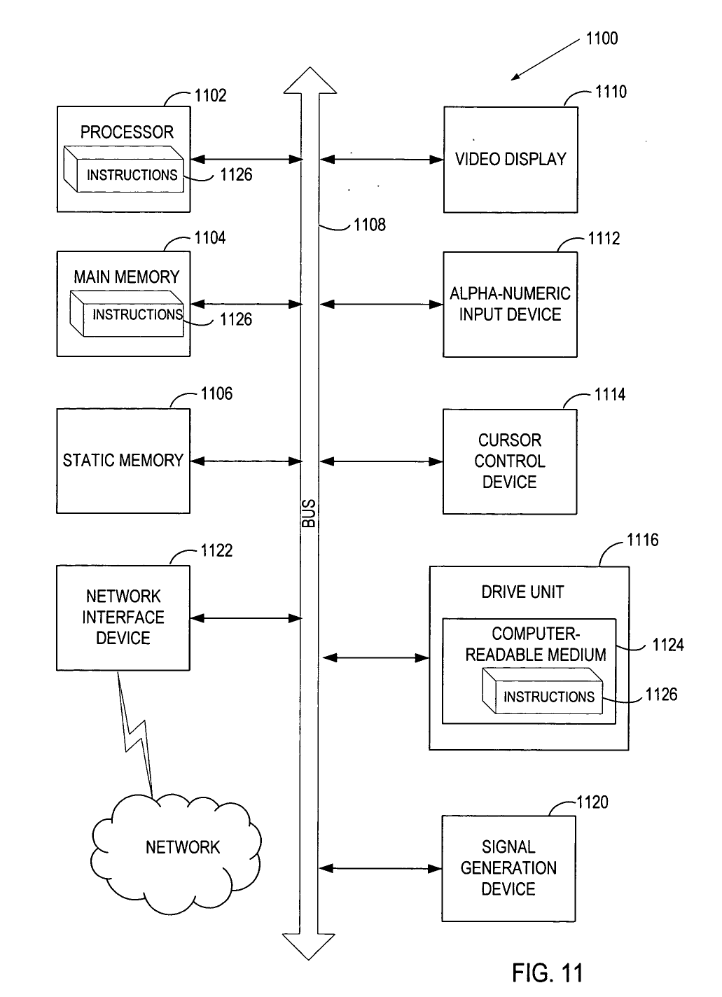

FIG. 11 shows a diagrammatic representation of machine in the exemplary form of a computer system 1100 within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a cursor control device 1114 (e.g., a mouse), a disk drive unit 1116, a signal generation device 1120 (e.g., a speaker) and a network interface device 1122.

The disk drive unit 1116 includes a machine-readable medium 1124 on which is stored one or more sets of instructions (e.g., software 1126) embodying any one or more of the methodologies or functions described herein. The software 1126 may also reside, completely or at least partially, within the main memory 1104 and/or within the processor 1102 during execution thereof by the computer system 1100, the main memory 1104 and the processor 1102 also constituting machine-readable media.

The software 1126 may further be transmitted or received over a network 1128 via the network interface device 1122.

While the machine-readable medium 1124 is shown in an exemplary embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention. The term “machine-readable medium” shall accordingly be taken to included, but not be limited to, solid-state memories, optical and magnetic media, and carrier wave signals.

Thus, a method and apparatus for managing online payment accounts of participants of network-based marketplaces have been described. Although the present invention has been described with reference to specific exemplary embodiments, it will be evident that various modifications and changes may be made to these embodiments without departing from the broader spirit and scope of the invention. Accordingly, the specification and drawings are to be regarded in an illustrative rather than a restrictive sense.

What is claimed is:

1. An apparatus for maintaining online accounts within an online payment system, the apparatus comprising:
a linked accounts manager to maintain a master account for a master account holder, and to maintain one or more sub-accounts linked to the master account for one or more sub-account holders; and
a funding controller to fund the one or more sub-accounts using at least one funding source of the master account.

2. The apparatus of claim 1 wherein the fund controller is to fund the one or more sub-accounts by receiving funding information specified by the master account holder for the one or more sub-accounts, and transferring funds from the at least one funding source of the master account to the one or more sub-accounts based on the funding information.

3. The apparatus of claim 2 wherein the funding information indicates at least one of a funding amount, a spending limit, and a permission to share the at least one funding source of the master account.

4. The apparatus of claim 1 wherein the linked accounts manager is further to allow the master account holder to access the one or more sub-accounts.

5. The apparatus of claim 1 wherein the linked accounts manager is further to associate one of the one or more sub-accounts with a new funding source, and to detach said one of the one or more sub-accounts from the master account.

6. The apparatus of claim 1 wherein the linked accounts manager is further to maintain separate transaction records for the master account and each of the one or more sub-accounts.

7. The apparatus of claim 1 further comprising:
a linked accounts creator to create the one or more sub-accounts for the master account based on a request of the master account holder.

8. The apparatus of claim 7 wherein the created sub-accounts are new accounts.

9. The apparatus of claim 7 wherein the created sub-accounts are accounts previously maintained within the online payment system.

10. A method for maintaining online accounts within an online payment system, the method comprising:
maintaining a master account for a master account holder;
maintaining one or more sub-accounts linked to the master account for one or more sub-account holders; and
funding the one or more sub-accounts using at least one funding source of the master account.

11. The method of claim 10 wherein funding the one or more sub-accounts comprises:
receiving funding information specified by the master account holder for the one or more sub-accounts; and
transferring funds from the at least one funding source of the master account to the one or more sub-accounts based on the funding information.

12. The method of claim 11 wherein the funding information indicates at least one of a funding amount, a spending limit, and a permission to share the at least one funding source of the master account.

13. The method of claim 10 further comprising:
allowing the master account holder to access the one or more sub-accounts.

14. The method of claim 10 further comprising:
associating one of the one or more sub-accounts with a new funding source; and
detaching said one of the one or more sub-accounts from the master account.

15. The method of claim 10 further comprising:
maintaining separate transaction records for the master account and each of the one or more sub-accounts.

16. The method of claim 10 further comprising:
creating the one or more sub-accounts for the master account based on a request of the master account holder.

17. The method of claim 16 wherein the created sub-accounts are new accounts.

18. The method of claim 16 wherein the created sub-accounts are accounts previously maintained within the online payment system.

19. A computer readable medium comprising instructions, which when executed on a processor, cause the processor to perform a method comprising:
maintaining a master account for a master account holder;
maintaining one or more sub-accounts linked to the master account for one or more sub-account holders; and
funding the one or more sub-accounts using at least one funding source of the master account.
